(19) United States
(12) Patent Application Publication
(10) Pub. No.: US 2018/0332450 A1
(43) Pub. Date: Nov. 15, 2018

(54) METHOD, SERVER, AND COMPUTER-READABLE RECORDING MEDIUM FOR RIDE HOTSPOT PREDICTION

(71) Applicant: Acer Incorporated, New Taipei City (TW)

(72) Inventors: Pei-Jung Chen, New Taipei City (TW); Yin-Hsong Hsu, New Taipei City (TW); Chien-Hung Li, New Taipei City (TW); Tsung-Hsien Tsai, New Taipei City (TW); Chun-Hsien Li, New Taipei City (TW)

(73) Assignee: Acer Incorporated, New Taipei City (TW)

(21) Appl. No.: 15/974,684

(22) Filed: May 8, 2018

(30) Foreign Application Priority Data
May 12, 2017 (TW) 106115686

(51) Int. Cl. H04W 4/42; G06F 17/30; G06N 5/02

(52) U.S. Cl. CPC H04W 4/42; G06Q 50/30; G06N 5/022; G06F 17/30241

(57) ABSTRACT

A method, a server, and a computer-readable recording medium for ride hotspot prediction are provided. The method is applicable to the server and includes the following steps. First, multiple pieces of ride data are obtained, wherein each piece of the ride data includes data respectively associated with candidate factors and a ride spot. Next, data clustering is performed on the ride data according to different regions. At least one positively-related factor which has a positive relation with crowds is selected from the candidate factors by using the ride data for each of the regions to accordingly calculate and generate hotspots in each of the regions.

### CROSS-REFERENCE TO RELATED APPLICATION

This application claims the priority benefit of Taiwan application serial no. 106115686, filed on May 12, 2017. The entirety of the above-mentioned patent application is hereby incorporated by reference herein and made a part of this specification.

### BACKGROUND OF THE INVENTION

### 1. Field of the Invention

The invention relates to a method, a system and a computer-readable recording medium for hotspot prediction, and more particularly, relates to a method, a system and a computer-readable recording medium for ride hotspot prediction.

### 2. Description of Related Art

With the gradual integration of information technology and life, many industries are able to attain industrial transformation and upgrading through cloud computing and massive data analysis. In an example of the taxi industry, to predict ride hotspots of passengers by using existing ride data in order to improve passenger load efficiency for taxi drivers is one of the goals to be achieved.

### SUMMARY OF THE INVENTION

Accordingly, a method, a server and a computer-readable recording medium for ride hotspot prediction are proposed, where ride hotspots in different regions are predictable according to different factors. As a result, passenger load efficiency may be improved for taxi drivers to provide beneficial development for the taxi industry market.

In an embodiment of the invention, the proposed method is applicable to a server and includes the following steps. First, multiple pieces of ride data are obtained, where each piece of the ride data includes data respectively associated with candidate factors and a ride spot. Next, data clustering is performed on the ride data according to different regions. At least one positively-related factor which has a positive relation with crowds is selected from the candidate factors by using the ride data for each of the regions to accordingly calculate and generate hotspots in each of the regions.

According to an embodiment of the invention, the proposed server includes a memory and processor. The memory is configured to store data. The processor is coupled to the memory and configured to obtain multiple pieces of ride data, perform data clustering on the ride data according to different regions, and select at least one positively-related factor which has a positive relation with crowds from the candidate factors by using the ride data to accordingly calculate and generate hotspots in each of the regions, where each piece of the ride data includes data respectively associated with candidate factors and a ride spot.

In an embodiment of the invention, the proposed computer-readable recording medium records programming codes to be loaded into the server so as to perform the steps in the proposed method for ride hotspot prediction.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of a server according to an embodiment of the invention.

FIG. 2 illustrates a flowchart of a method for ride hotspot predication according to an embodiment of the invention.

FIG. 3 illustrates a flowchart for selecting factors according to an embodiment of the invention.

FIG. 4 illustrates a flowchart for calculating hotspots according to an embodiment of the invention.

FIG. 5 illustrates a flowchart for generating a hotspot database according to an embodiment of the invention.

FIG. 6 illustrates a flowchart for obtaining to-be-calculated ride data according to an embodiment of the invention.

FIG. 7 illustrates a flowchart for generating a prediction hotspot database according to an embodiment of the invention.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

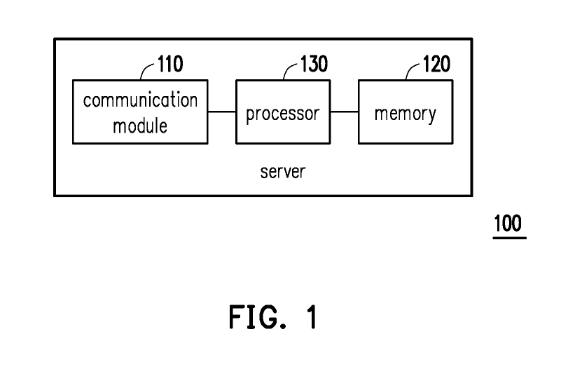

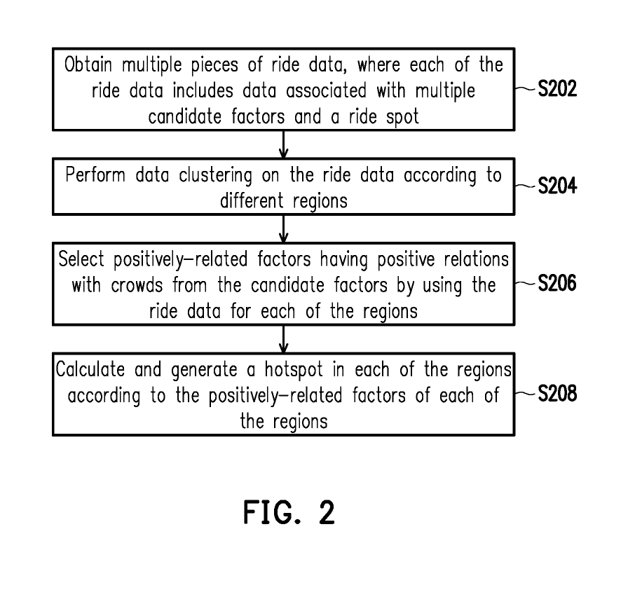

FIG. 1 is a block diagram illustrating a server according to an embodiment of the invention. It should, however, be noted that this is merely an illustrative example and the invention is not limited in this regard. All components of the server and their configurations are first introduced in FIG. 1. The functionalities of the components are disclosed in more detail in conjunction with FIG. 2.

With reference to FIG. 1, a server 100 may include a communication module 110, a memory 120 and a processor 130, where the processor 130 is coupled to the communication module 110 and the memory 120. In this embodiment, the server 100 may be a computer system with computing capability such as an application server, a cloud server, a database server, or a work station. In addition, the server 100 may also provide a platform for connection and interaction with other devices.

The communication module 110 is configured to provide the server 100 to be connected with other devices for interaction and data transmission, and may be, for example, an electronic component such as a wireless network communication chip or antenna with a WiMAX, Wi-Fi, 2G, 3G, 4G standard.

The memory 120 is configured to store data, programming codes or the like, and may be, for example, a stationary or mobile device in any form such as a random access memory (RAM), a read-only memory (ROM), a flash memory, a hard drive or other similar devices, or a combination of the above.

The processor 130 is configured to control operations among the components in the server 100, and may be, for example, a central processing unit (CPU), or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices.

Detailed steps of how the server 100 performs the proposed methods would be illustrated along with each component hereafter.

FIG. 2 illustrates a flowchart of a method for ride hotspot predication according to an embodiment of the invention, and the flow of FIG. 2 may be implemented by each component in the server 100 of FIG. 1.

Referring to FIG. 2 along with FIG. 1, the processor 130 of the server 100 obtains multiple pieces of ride data, where each piece of the ride data includes data respectively associated with multiple candidate factors and a ride spot (step S202). Herein, the candidate factors may be, for example, environmental information associated with time, events and locations such as time, days of the week, special holiday or not, temperature, weather, concert or not, exhibition or not, department store anniversary or not, MRT station nearby or not, MRT inbound and outbound volumes, and so forth. The ride spot may be a boarding spot of a passenger represented by GPS information, actual address, nearest intersection, nearby landmarks, etc.

Next, the processor 130 performs data clustering on the ride data according to different regions (step S204). In other words, after data clustering is performed, each region would have its own corresponding ride data. In this embodiment, the processor 130 may define the regions based on counties, cities, or administrative regions. Nonetheless, in other embodiments, the processor 130 may divide all the regions with a fixed area (e.g., in 5 square kilometers). The invention is not limited in this regard.

Next, the processor 130 selects positively-related factors having positive relations with crowds from the candidate factors by using the ride data for each of the regions (step S206), calculates and generates hotspots in each of the regions according to the positively-related factors of each of the regions (step S208). Herein, the processor 130 only retains the positively-related factors having positive relations with crowds so as to assist drivers locate the hotspots with ride demands in each of the regions by using the positively-related factors. It should be noted that, the number of positively-related factor and hotspot in each of the regions may also be singular based on actual scenarios. The invention is not limited in this regard. Details for selecting the positively-related factors in step S206 and calculating the hotspots in step S208 will be described thoroughly in the following embodiments.

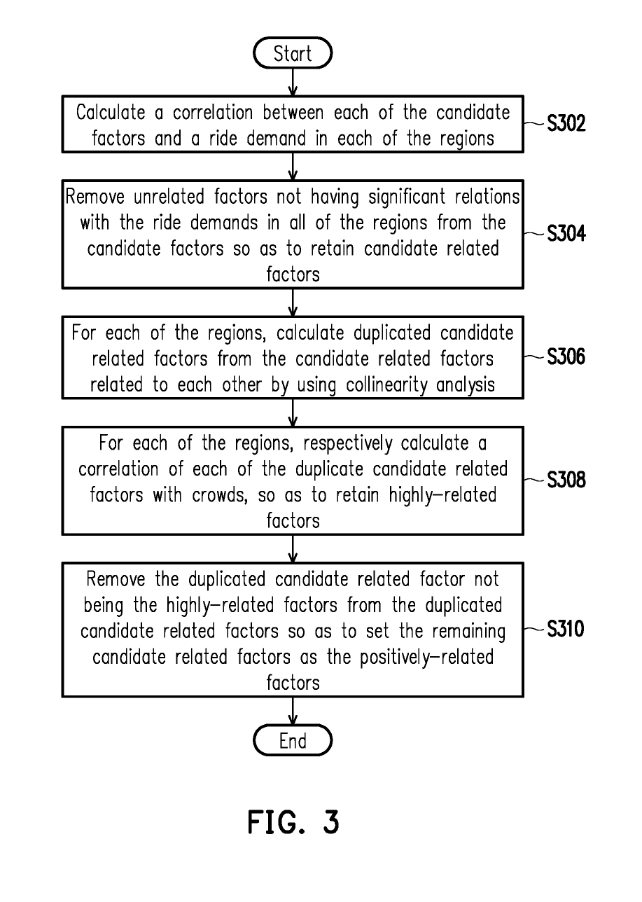

FIG. 3 illustrates a flowchart for selecting the positively-related factors according to an embodiment of the invention, and the flow of FIG. 3 is detailed description for step S206 and may be implemented by each component in the server 100 in FIG. 1.

Referring to FIG. 3 along with FIG. 1, first, the processor 130 of the server 100 calculates a correlation between each of the candidate factors and a ride demand in each of the regions (step S302) and removes unrelated factors not having significant relations with the ride demands in all of the regions from the candidate factors so as to retain candidate related factors (step S304). It should be noted that, the number of unrelated factor and candidate related factor in each of the regions may also be singular based on actual scenarios. In detail, after obtaining the ride data, the processor 130 would respectively inspect data of each of the candidate factors to identify the candidate factors that are less likely to be associated with the ride demands. For instance, when the data of the candidate factor “concert or not” is “yes” (or represented by “1”) or the data of the candidate factor “weather” is “rainy” in the ride data, those are likely to become the candidate related factors having significant relations with the ride demand. On the other hand, the candidate factor “MRT inbound volume” in the ride data is likely to become the candidate factor not having the significant relation with the ride demand (i.e. the unrelated factor). At this stage, the processor 130 first removes the unrelated factors not having significant relations with all of the regions and then performs analysis on each region individually based on different ride demands so as to adaptively select the related factors that are positively-related with crowds in each of the regions from the candidate related factors.

Specifically, for each of the regions, the processor 130 first calculates duplicated candidate related factors from the candidate related factors related to each other by using collinearity analysis (step S306) so as to prevent the subsequent analysis and the prediction result from being affected by multiple candidate related factors that are highly correlated. It should be noted that, the number of duplicated candidate related factor in each of the regions may also be singular based on actual scenarios. Next, for each of the regions, the processor 130 respectively calculates a correlation between each of the duplicate candidate related factors and crowds so as to retain a highly-related factors (step S308). In other words, the processor 130 removes the duplicated candidate related factor not being the highly-related factors from the duplicate candidate related factors so as to set the remaining candidate related factors as the positively-related factors (step S310). In general, after the unrelated factors and the duplicated candidate related factors among all of the candidate factors in each of the regions are removed, the corresponding positively-related factors may be obtained accordingly.

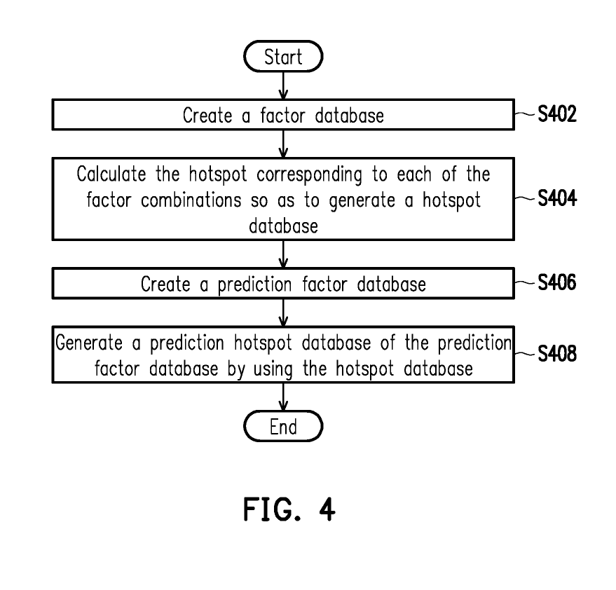

FIG. 4 illustrates a flowchart for calculating hotspots according to an embodiment of the invention, and the flow of FIG. 4 is a detailed description for step S208 and may be implemented by each component in the server 100 in FIG. 1. It should be noted that, the flow of FIG. 4 is an example for calculating the hotspots in one of the regions, whereas the hotspots of the rest of the regions may also be calculated in a similar fashion.

Referring to FIG. 4 along with FIG. 1, the processor 130 of the server 130 first creates a factor database (step S402), where the factor database is created according to different factor combinations generated by data of the positively-related factors. For instance, if the positively-related factors are “concert or not”, “exhibition or not” and “special holiday or not”, the factor database may have up to 8 different factor combinations.

Next, the processor 130 calculates a hotspot corresponding to each of the factor combinations so as to generate a hotspot database (step S404). Herein, each of the factor combinations may include multiple pieces of ride data corresponding to the different ride spots. For instance, if one of the factor combinations includes “concert”, “no exhibition” and “special holiday” (recorded as (1, 0, 1)), it is possible that the ride spots located around the concert location. Therefore, the processor 130 sets a center point of the ride spots or the concert location as the hotspot of the factor combination (1, 0, 1). In some embodiments, the number of hotspot may be plural. For example, if one of the factor combinations includes “no concert”, “exhibition” and “special holiday” (recorded as (0, 1, 1)) and the ride spots fall around two different exhibition locations, the processor 130 then sets the both locations as the hotspots corresponding the factor combination (0, 1, 1). In the following embodiments, the hotspot corresponding to each of the factor combinations is referred to as “a first hotspot”.

However, when hotspot data in the hotspot database or factor combinations in the factor database are insufficient, the processor 130 may create a prediction factor database by using other factor combinations associated with a current factor combination in the factor database (step S406) and generate a prediction hotspot database of the prediction factor database by using the hotspot database (S408), where data of the positively-related factors in other factor combinations is partially identical to data of the positively-related factors in the current factor combination. In the following embodiments, the hotspot corresponding to each of other factor combinations is referred to as “a second hotspot”. Besides, the processor 130 may further obtain regular ride spots according to a basic condition for situations unrelated to any special events or holidays, including a department store or a train station. In the following embodiments, the hotspots obtained by using the basic condition are referred to as “a basic hotspot”, and the prediction hotspot database herein will include the first hotspots, the second hotspots, the basic hotspots, and the factor combinations corresponding thereto for all regions. Details for generating the hotspot database and the prediction hotspot database will be described thoroughly in the following embodiments.

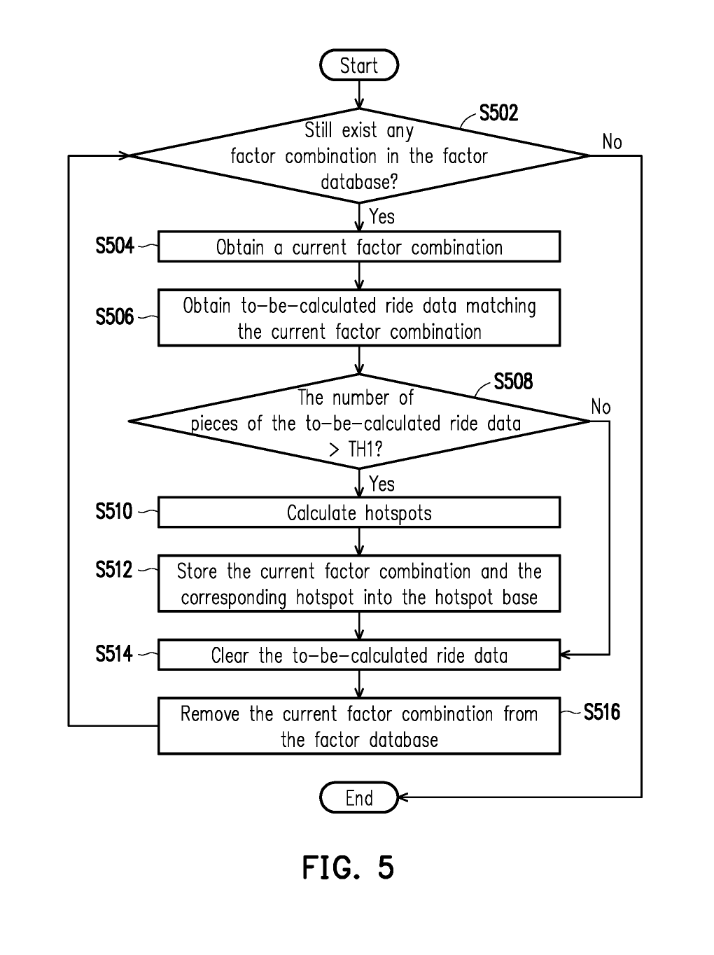

FIG. 5 illustrates a flowchart for generating a hotspot database according to an embodiment of the invention and the flow of FIG. 5 may be implemented by each component in the server 100 of FIG. 1. It should be noted that, the flow of FIG. 5 is an example for generating the hotspot database in one of the regions, whereas the hotspot databases of the rest of the regions may also be generated in a similar fashion.

Referring to FIG. 5 along with FIG. 1, the processor 130 of the server 100 first determines whether there still exists any factor combination in the factor database (step S502). When the processor 130 determines that there still exists one or more factor combinations in the factor database, the processor 130 would obtain one of the factor combinations (referred to as “the current factor combination”, step S504) and obtain to-be-calculated ride data matching the current factor combination (step S506). The to-be-calculated ride data refers to all of the ride data matching the current factor combination.

Next, the processor 130 determines whether the number of pieces of the to-be-calculated ride data is greater than a first predetermined number TH1 (step S508), so as to determine whether the sample size of the ride data is too small to be used as a reference for calculating the hotspots. When the number of pieces of the ride data is greater than the first predetermined TH1, the processor 130 calculates the hotspot corresponding to the current factor combination (step S510), where the method for calculating the hotspot may refer to related description for step S404 and would not be repeated hereinafter for brevity.

Next, the processor 130 stores the current factor combination and the corresponding hotspot into the hotspot database (step S512), clears the to-be-calculated ride data (step S514), and removes the current factor combination from the factor database (step S516) (i.e. indicating that the current factor combination has been processed). On the other hand, when the number of pieces of the to-be-calculated ride data is not greater than the first predetermined number TH1, i.e. the sample size of the ride data is too small to be used as the reference for calculating the hotspot, the processor 130 would directly proceed to execute step S514 and step S516.

After the current factor combination is processed, the processor 130 returns to step S502 to determine whether there exist other factor combinations in the factor database. If yes, the processor 130 performs steps S504 to S516 for other factor combinations. If no, it means that the factor combinations in the factor database have been processed completely so the processor 130 would end the flow of FIG. 5 for generating the hotspot database.

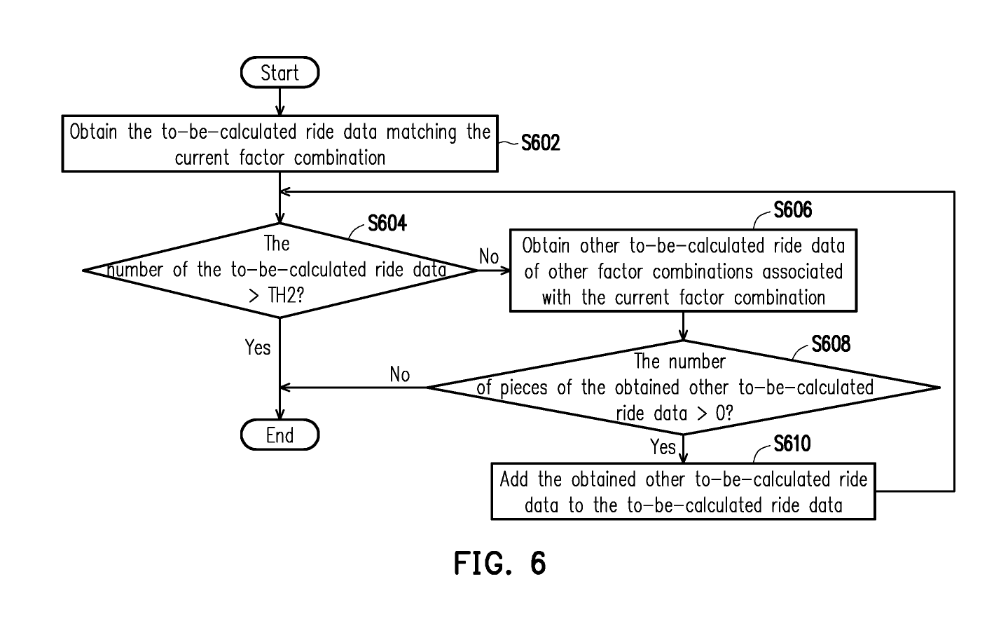

It should be noted that, in an embodiment, while obtaining the to-be-calculated ride data matching the current factor combination in step S506, the processor 130 may obtain the to-be-calculated ride data according to the flowchart illustrated in FIG. 6 according to an embodiment of the invention. The flow of FIG. 6 may be implemented by each component in the server 100 in FIG. 1.

After obtaining the to-be-calculated ride data matching the current factor combination (step S602), the processor 130 of the server 100 would determine whether the number of pieces of the to-be-calculated ride data is greater than a second predetermined number TH2 (step S604). Herein, the second predetermined number TH2 may be greater than or equal to the first predetermined number TH1 so that step S510 and step S512 for calculating the hotspot may be prevented from being skipped due to the number of the to-be-calculated ride data still not being greater than the first predetermined number TH1 after step S508 is executed. When the number of pieces of the to-be-calculated ride data is greater the second predetermined number TH2, the processor 130 ends the flow of FIG. 6 and continues to execute the flow of step S508 in FIG. 5.

On the other hand, when the number of pieces of the to-be-calculated ride data is not greater than the second predetermined number TH2, the processor 130 would obtain another to-be-calculated ride data of another factor combination associated with the current factor combination (step S606) and determines whether the number of pieces of the obtained another to-be-calculated ride data is greater than 0 (step S608), where data of the positively-related factors in the another factor combination is partially identical to data of the positively-related factors in the current factor combination. For instance, assume that the current factor combination includes “concert”, “no exhibition” and “special holiday” (recorded as (1, 0, 1)) and the number of pieces of the to-be-calculated ride data is not greater than the second predetermined number TH2, the processor 130 would obtain new to-be-calculated ride data of another new factor combination having the positively-related factor “concert” (i.e., taking the factor combinations (1, 1, 1), (1, 0, 0) and (1, 1, 0) into consideration).

When determining that the number of pieces of the obtained another to-be-calculated ride data is greater than 0, the processor 130 would add the obtained another to-be-calculated ride data to the to-be-calculated ride data (step S610) and then return to step S604 to re-determine whether the number of pieces of the updated to-be-calculated ride is greater than the second predetermined number TH2. When the processor 130 determines that the obtained another to-be-calculated ride data is 0, it means that there exists no other factor combination and other to-be-calculated ride data having the data of the positively-related factor for references. Accordingly, the processor 130 ends the flow of FIG. 6 and continues to execute step S508 in FIG. 5.

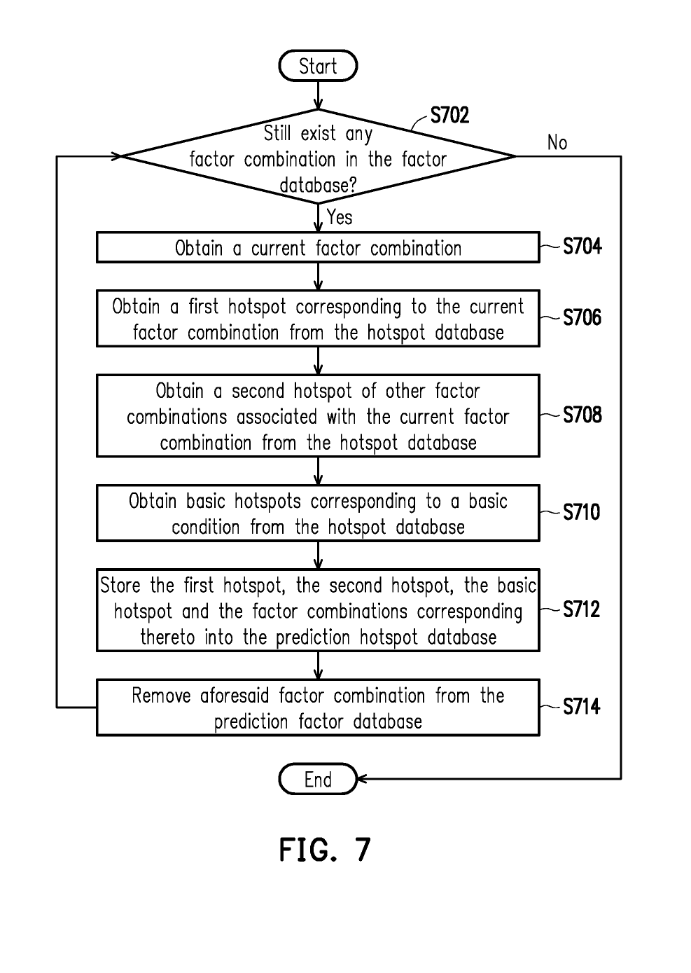

FIG. 7 illustrates a flowchart for generating a prediction hotspot database according to an embodiment of the invention and the flow of FIG. 7 may be implemented by each component in the server 100 of FIG. 1. It should be noted that, the flow of FIG. 7 is an example for generating the prediction hotspot database in one of the regions, whereas the prediction hotspot databases of the rest of the regions may also be generated in a similar fashion.

Referring to FIG. 7 along with FIG. 1, the processor 130 of the server 100 first determines whether there still exists any factor combination in the prediction factor database (step S702). When the processor 130 determines that there still exist one or more factor combinations in the prediction factor database, the processor would obtain one of the factor combinations (referred to as “the current factor combination”, step S704) and obtain a first hotspot corresponding to the current factor combination from the hotspot database (step S706). Next, the processor 130 obtains a second hotspot of other factor combinations associated with the current factor combination from the hotspot database (step S708) so as to increase the number of the hotspots. In addition, the processor obtains a basic hotspot corresponding to a basic condition from the hotspot database (step S710). Description regarding the first hotspot, the second hotspot and the basic hotspot may refer to the related paragraphs above, which are not repeated hereinafter. It should also be noted that, the number of first hotspot, second hotspot, and basic hotspot in each of the regions may also be plural based on actual scenarios.

Then, the processor 130 stores the first hotspot, the second hotspot, the basic hotspots and the factor combinations corresponding thereto into the prediction hotspot database (step S712) and removes the aforesaid factor combinations from the prediction factor database (step S714). Next, the processor 130 returns to step S702 to determine whether there still exists any factor combination in the prediction factor database. If yes, the processor 130 would perform the flow of step S704 to S714 for other factor combinations. If not, it means that all the factor combinations in the prediction factor database have been processed, and the processor 130 would end the flow of FIG. 7 for generating the prediction hotspot database.

As a side note, the flow of FIG. 2 to FIG. 7 may be executed by the server 100 through the communication module 110 to obtain the latest ride data on a regular basis. In this way, the latest ride spot information may be obtained and provided to the taxi business to assist taxi drivers to improve passenger load efficiency.

The invention also provides a non-transitory computer-readable recording medium, which records computer program composed of a plurality of program instructions (for example, an organization chart, establishing program instruction, a table approving program instruction, a setting program instruction, and a deployment program instruction, and etc.). After these program instructions are loaded into, the system for hotspot prediction 100 and executed, the steps in the proposed method as illustrated above would be completed.

In summary, the method, the server and the computer-readable recording medium for ride hotspot prediction proposed in the invention are able to predict ride hotspots in different regions according to different factors. As a result, passenger load efficiency may be improved for taxi drivers to provide beneficial development for the taxi industry market.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for ride hotspot prediction, comprising:
obtaining a plurality pieces of ride data, wherein each piece of the ride data respectively comprises data associated with a plurality of candidate factors and a ride spot;
performing data clustering on the ride data according to different regions;
selecting at least one positively-related factor having a positive relation with crowds from the candidate factors by using the ride data for each of the regions; and
calculating and generating at least one hotspot in each of the regions according to the at least one positively-related factor of each of the regions.

2. The method according to claim 1, wherein the step of selecting the at least one positively-related factor having the positive relation with crowds from the candidate factors by using the ride data for each of the regions comprises:
respectively calculating a correlation between each of the candidate factors and a ride demand in each of the regions;
removing at least one unrelated factor not having a significant relation with the ride demands in all of the regions from the candidate factors so as to retain a plurality of candidate related factors among the candidate factors; and
selecting the at least one positively-related factor having the positive relation with the crowds from the candidate related factors for each of the regions.

3. The method according to claim 2, wherein the step of selecting the at least one positively-related factor having the positive relation with crowds from the candidate related factors for each of the regions comprises:
calculating at least one duplicated candidate related factor from the candidate related factors related to each other by collinearity analysis;
respectively calculating a correlation between each of the duplicated candidate related factors and the crowds so as to retain a highly-related factor among the duplicated related factors; and
removing the duplicated candidate related factor not being the highly-related factor from the duplicated candidate related factors so as to set the remaining of the candidate related factors as the at least one positively-related factor.

4. The method according to claim 1, wherein the step of calculating and generating the at least one hotspot in each of the regions according to the at least one positively-related factor of each of the regions comprises:
for each of the regions,
generating a plurality of factor combinations according to the ride data of the at least one positively-related factor to create a factor database;
calculating a plurality of hotspots corresponding to each of the factor combinations by using the factor combinations and the ride spots in the ride data to generate a hotspot database;
creating a prediction factor database by using a part of the at least one positively-related factor in each of the factor combinations in the factor database; and
generating a prediction hotspot database of the prediction factor database by using the hotspot database.

5. The method according to claim 4, wherein the step of generating the hotspot database comprises:
for each of the regions, when there exists at least one of the factor combinations in the factor database:
obtaining a current factor combination in the factor combinations;
obtaining to-be-calculated ride data matching the current factor combination from the ride data of the region;
determining whether the number of pieces of the to-be-calculated ride data is greater than a first predetermined number;
if yes, calculating the hotspots corresponding to the current factor combination by using the to-be-calculated ride data, storing the current factor combination and the hotspots corresponding to the current factor combination into the hotspot database, and clearing the to-be-calculated ride data and the current factor combination; and
if not, clearing the to-be-calculated data and the current factor combination.

6. The method according to claim 5, wherein for each of the regions, the step of obtaining the to-be-calculated ride data matching the current factor combination from the ride data of the region comprises:
when the number of pieces of the to-be-calculated ride data matching the current factor combination in the ride data is not greater than a second predetermined number:
obtaining another factor combination associated with the current factor combination, wherein data of the positively-related factors in the another factor combination is partially identical to data of the positively-related factors in the current factor combination;
when the number of pieces of another to-be-calculated ride data of the another factor combinations is greater than 0, adding the another to-be-calculated ride data to the to-be-calculated data.

7. The method according to claim 6, wherein after the step of adding the another to-be-calculated ride data to the to-be-calculated data, the method further comprises:
determining whether the number of pieces of the to-be-calculated data added to the another to-be-calculated ride data is greater than the second predetermined number; and
if not, generating new to-be-calculated ride data according to a new another factor combination associated with the current factor combination.

8. The method according to claim 4, wherein the step of generating the prediction hotspot database of the prediction factor database by using the hotspot database comprises:
for each of the regions, when there exists at least one of the factor combinations in the prediction database:
obtaining a current factor combination in the factor combinations, and obtaining the hotspot corresponding to the current factor combination from the hotspot database to be at least one first hotspot;
obtaining the hotspot corresponding to another factor combination associated with the current factor combination to be at least one second hotspot;
obtaining at least one basic hotspot satisfying a basic condition; and
adding the at least one first hotspot, the at least one second hotspot, the at least one basic hotspot, and the factor combinations corresponding thereto into the prediction hotspot database.

9. A server, comprising:
a memory, configured to store data; and
a processor, coupled to the memory, and configured to execute steps of:
obtaining a plurality pieces of ride data, wherein each piece of the ride data respectively comprises data associated with a plurality of candidate factors and a ride spot;
performing data clustering on the ride data according to different regions;
selecting at least one positively-related factor having a positive relation with crowds from the candidate factors by using the ride data for each of the regions; and
calculating and generating at least one hotspot in each of the regions according to the at least one positively-related factor of each of the regions.

10. A non-transitory computer-readable recording medium, recording computer programs to be loaded into a processor in a server to perform steps of:
obtaining a plurality pieces of ride data, wherein each piece of the ride data respectively comprises data associated with a plurality of candidate factors and a ride spot;
performing data clustering on the ride data according to different regions;
selecting at least one positively-related factor having a positive relation with crowds from the candidate factors by using the ride data for each of the regions; and
calculating and generating at least one hotspot in each of the regions according to the at least one positively-related factor of each of the regions.
